(19) United States
(12) Patent Application Publication
(10) Pub. No.: US 2023/0134517 A1
(43) Pub. Date: May 4, 2023

(54) SYSTEMS AND METHODS FOR DETERMINING BENEFICIARY COSTS BASED ON BENEFIT INFORMATION

(71) Applicant: RIS Rx, Newport Beach, CA (US)

(72) Inventors: Gerard Rivera, Yorba Linda, CA (US); Stephen Hom, Orange, CA (US); Daniel Lozano, Whittier, CA (US)

(21) Appl. No.: 17/516,331

(22) Filed: Nov. 1, 2021

(51) Int. Cl. G06Q 40/08; G06Q 10/10

(52) U.S. Cl. CPC G06Q 40/08; G06Q 10/1057

(57) ABSTRACT

Systems and methods for determining beneficiary costs based on user-specific benefit information. Exemplary implementations may: store benefit entity information and cohort information, obtain user input submitted by a user via a user interface including beneficiary information identifying a first beneficiary and therapy information identifying a first therapy; obtained stored benefit information associated with a first benefit entity and stored cohort information associated with a first group of beneficiaries; determine whether the first beneficiary qualifies for additional benefits; determine a beneficiary cost for the first therapy based on the stored information and the determination whether the first beneficiary qualifies for additional benefits; and effectuate presentation of the beneficiary cost via the user interface.

### FIELD OF THE DISCLOSURE

The present disclosure relates to systems and methods for determining beneficiary costs based on benefit information.

### BACKGROUND

Individual benefit entities (i.e., insurance companies, insurance agencies, etc.) may have systems to determine therapy prices based on benefits provided by the individual benefit entities. User's seeking to determine therapy prices may have to check multiple search engines and applications in order to find information pertaining to multiple benefit entities and/or to verify whether they qualify for additional benefits provided by commercial entities and/or other types of entities. Users may be unaware that they qualify for these additional benefits in addition to their private benefits.

### SUMMARY

The present disclosure relates to a system to determine therapy prices for a user based on the user's benefits provided by a benefit entity (i.e., insurance company, insurance agengy, etc.) and/or whether the user qualifies for additional benefits provided by one or more commercial entities. The system includes a database storing information pertaining to multiple benefit entities, various sets of benefit parameters (i.e., benefit plans, insurance plans, etc.), cohorts (i.e., groups of beneficiaries, insurance groups, etc.), and/or other information. Users provide user input, via a user interface, specifying information regarding the therapy (e.g., drugs, medical devices, treatments, etc.) seeking to be purchase. Information inputed by the users may include their benefit (i.e., insurance) information, benefit parameters (i.e., insurance plans), and/or other identifying information. Based on the inputed information, the system may determine a group of beneficiaries that the user belongs to. The system may make a determination whether the benefit entity associated with the user is a private benefit entity or a public benefit entity. The system may also access stored information from the database to determine whether the user qualifies for additional benefits from one or more commercial entities based on the user's identifying information, the user's benefit information (i.e., whether the user has private or public insurance), and/or other information. A beneficiary cost may be calculated based on the determination and/or the user's benefit information. The beneficiary cost may define an amount to be paid by the user for the therapy subsequent to various benefit entities providing payment on behalf of the user. The system may then present the beneficiary cost to the user via the user interface.

One aspect of the present disclosure relates to a system configured for determining beneficiary costs based on benefit information. The system may include one or more hardware processors configured by machine-readable instructions and electronic storage. The machine-readable instructions may include one or more instruction components. The instruction components may include one or more of an information component, a qualification component, a cost component, a presentation component and/or other instruction components.

The electronic storage may store benefit entity information, cohort information, and/or other information. The benefit entity information may be associated with benefit entities that provide benefits to beneficiaries. The benefits may include payment for health and medical services on behalf of the beneficiary and/or other forms of benefits. The benefit entity information may include sets of benefit parameters (e.g., insurance plans, insurance policy, etc.) that characterize the benefits provided by the individual benefit entities, and/or other information. The benefit entity information associated with the benefit entities may indicate whether the individual benefit entities have a public status, a private status, and/or other statuses. The benefits may include payment for health and medical services on behalf of the beneficiary and/or other forms of benefits. The cohort information may be associated with groups of beneficiaries. Individual beneficiaries belonging to an individual group of beneficiaries may receive the same benefits that are defined by an individual set of benefit parameters.

The information component may be configured to obtain user input submitted by a user via a user interface. The user input may include beneficiary information, therapy information, and/or other information. The beneficiary information may identify at least one of a first beneficiary, a first benefit entity, a first set of benefit parameters, and/or other elements. The first set of benefit parameters may characterize benefits provided by the first benefit entity to the first beneficiary. The therapy information may identify a first therapy intended for purchase by the first beneficiary and/or other therapies.

The information component may be configured to, responsive to obtaining user input, obtain stored benefit information associated with the first benefit entity, stored cohort information associated with a first group of beneficiaries, and/or other information. The first group of beneficiaries may receive benefits from the first benefit entity that are the same as the benefit received by the first beneficiary. Obtaining the stored benefit information associated with the first benefit entity may include obtaining an entity status for the first benefit entity. Obtaining the stored cohort information may include verifying the first set of benefit parameters characterizes the benefits received by the individual beneficiaries of the first group of beneficiaries.

The qualification component may be configured to determine whether the first beneficiary qualifies for additional benefits and/or other benefits. The determination may be based on one or more of the entity status of the first benefit entity, stored benefit information associated with the first benefit entity, stored cohort information associated with the first group of beneficiaries, beneficiary information obtained from the user, and/or other information. A determination that the first beneficiary qualifies for additional benefits may indicate one or more entities providing payment on behalf of the first beneficiary for the first therapy in addition to the benefits provided by the first benefit entity.

The cost component may be configured to determine a beneficiary cost. The beneficiary cost may be based on the stored benefit information associated with the first benefit entity, the stored cohort information associated with the first group of beneficiaries, the determination whether the first beneficiary qualifies for additional benefits, and/or other information. The beneficiary cost may indicate an amount to be paid by the first beneficiary for the first therapy. Determining the beneficiary cost may include calculating an entity-provided cost and/or other costs. The entity-provide cost may indicate an amount to be paid by one or more of the first benefit entity, the one or more entities providing additional benefits, and/or other entities. A portion of the entity-provided cost may be paid by the first benefit entity and/or may be defined by the first set of benefit parameters.

The presentation component may be configured to effectuate presentation of the beneficiary costs via the user interface. The beneficiary cost may be based on the entity-provided cost deducted from a total cost for the first therapy and/or other information.

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured for determining beneficiary costs based on benefit information, in accordance with one or more implementations.

FIG. 2 illustrates a method for determining beneficiary costs based on benefit information, in accordance with one or more implementations.

FIG. 3 illustrates an exemplary user interface, in accordance with one or more implementations.

### DETAILED DESCRIPTION

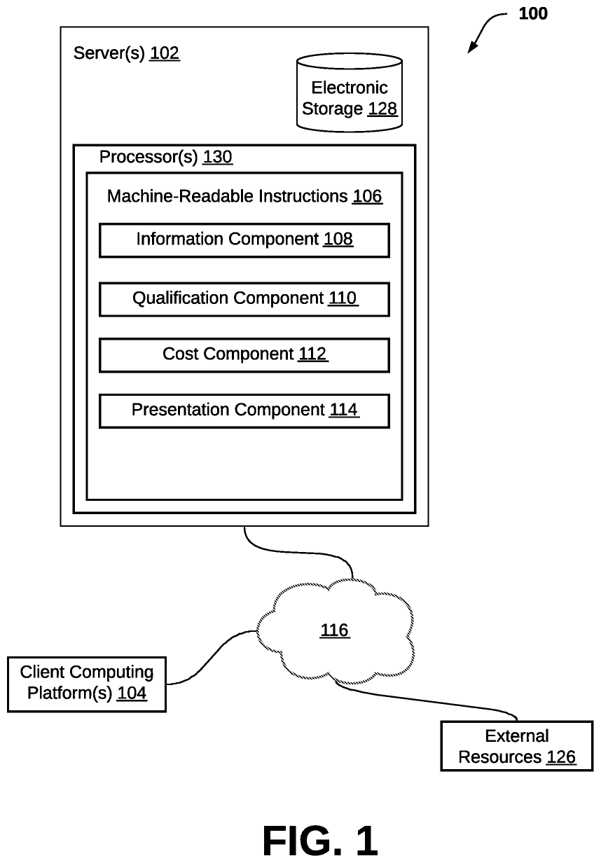

FIG. 1 illustrates a system 100 configured for determining beneficiary costs based on benefit information, in accordance with one or more implementations. In some implementations, system 100 may include one or more servers 102, client computing platform(s) 104, and/or other components. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may include electronic storage 128, one or more processors 130, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Electronic storage 128 may store benefit entity information, cohort information, and/or other information. The benefit entity information may be associated with benefit entities that provide benefits to beneficiaries. In some implementations, benefit entity information may include individual records for individual benefit entities. For example, a first record may include information pertaining to a first benefit entity. The first record may include a list of groups of beneficiaries (i.e., insurance group) associated with the first benefit entity, benefits provided by the first benefit entity, and/or other information pertaining to the first benefit entity. In some implementations, benefit entity information may specify relationships (i.e., contracts) between benefit entities and one or more of vendor entities, manufacture entities, and/or other types of entities. Based on the relationships, vendor entities and/or other entities may provide subsidized (i.e., discounted) therapies to the benefit entities and/or beneficiaries associated with the benefit entities. In some implementations, benefit entity information may reflect information from one or more external databases operated by the individual benefit entities. The external databases may be accessed by system 100 by obtaining permissions (i.e., licenses, authorizations, contracts, etc.) from the individual benefit entities operating the external databases. In some implementations, electronic storage 128 may include information that reflects information from external databases operated by vendor entities, manufacture entities, and/or other types of entities. The external databases may be accessed by the system by obtaining permissions (i.e., licenses, authorizations, contracts, etc.) from entities associated with the external databases.

The benefit entity information associated with the benefit entities may indicate whether the individual benefit entities have a public status, a private status, and/or other statuses. In some implementations, the status of a given benefit entity may determine qualifying criteria for beneficiaries, price to purchase benefits from the individual benefit entities, and/or other information. In some implementations, public benefit entities may be associated with and/or operated by a government entity (i.e., state-based exchanges, government contracted, etc.). In some implementations, private benefit entities may be associated with and/or operated by privatized entities (i.e., private companies, private firms, etc.). In some implementations, benefit entities (i.e., public benefit entities) may provide benefits to individuals who have purchased benefits (i.e., through a contract) and/or meet qualifying criteria.

The cohort information may be associated with groups of beneficiaries. In some implementations, electronic storage 128 may include information to identify the individual groups of beneficiaries, such as a group identification number and/or other information. Individual beneficiaries of a group of beneficiaries may receive the same benefits and/or receive benefits from the same benefit entity. The same benefits may be characterized by an individual set of benefit parameters. In some implementations, individual beneficiaries may belong to a group of beneficiaries by virtue of the individual beneficiaries being employed by the same employer. Individual beneficiaries may belong to a group of beneficiaries by virtue of the individual beneficiaries purchasing and/or being provided benefits by the same benefit plan, type of benefit plan, and/or other commonalities between the individual beneficiaries. In some implementations, benefits may be purchased by the individual beneficiaries and/or institutions associated with the individual beneficiaries (e.g., employers, education institutions, etc.). In some implementations, beneficiary information may include a type of plan associated with the individual beneficiaries. The types of plan may include HMO, PPO, EPO, POS, and/or other types of plans.

The benefit entity information associated with the benefit entities may include sets of benefit parameters. The individual sets of benefit parameters (i.e., insurance plans, healthcare plan, etc.) may characterize the benefits provided by the benefit entities to beneficiaries. The benefits provided by benefit entities may include payment for health and medical services on behalf of the beneficiary and/or other forms of benefits. In some implementations, individual sets of benefit parameters may include conditions of payment on behalf of the beneficiaries. For example, benefit entities may require beneficiaries to pay a given amount before payment on behalf of the beneficiary may occur. Individual sets of benefit parameters may depend on the type of plan associated with the individual beneficiaries and/or other information.

In some implementations, electronic storage 128 may include information associated with one or more vendor entities, manufacturer entities, and/or other types of entities. The vendor entities may provide therapies for purchase and/or other goods and services. In some implementations, stored information associated with individual vendor entities may include prices for one or more goods and/or services offered by the individual vendor entities. The manufacturer entities may produce and/or provide therapies for purchase and/or other goods and services. In some implemenations, stored information associated with one or more of the vendor entities, manufacturer entities, and/or other types of entities may include benefits offered by the one or more entities. In some implementations benefits may be in the form of discounted prices for goods and services.

Client computing platform(s) 104 may be configured by machine-readable instructions 106. Machine-readable instructions 106 may include one or more instruction components. The instruction components may include computer program components. The instruction components may include one or more of an information component 108, a qualification component 110, a cost component 112, presentation component 114, and/or other instruction components.

Information component 108 may be configured to obtain user input submitted by a user via a user interface. In some implementations, the user interface may include one or more user input fields for receiving user input. The user input may include beneficiary information, therapy information, and/or other information. The beneficiary information may identify at least one of a first beneficiary, a first benefit entity, a first set of benefit parameters, and/or other information. The first beneficiary may be identified by one or more of a name, date of birth, identification number, gender, and/or other information. The first beneficiary may be associated with the first benefit entity by virtue of the first benefit entity providing benefits to the first beneficiary. The first set of benefit parameters may characterize the benefits provided by the first benefit entity to the first beneficiary. In some implemenations, the first set of benefit parameters may define conditions of payment by the first benefit entity on behalf of the first beneficiary and/or other information.

In some implementations, the first set of benefit parameters may include individual benefit parameters characterizing a deductible cost, a ceiling cost, and/or other parameters. The deductible cost may indicate a required amount to be paid by the first beneficiary for the first therapy prior to the first benefit entity providing payment. The ceiling cost may indicate a maximum amount paid by the first benefit entity on behalf of the first beneficiary for the first therapy and/or a maximum amount paid by the first benefit entity within a given period of time (e.g., one year, five years, one month, three months, etc.). In some implementations, individual benefit parameters of the first set of benefit parameters may be based on the entity status of the first benefit entity. For example, the deductible cost, the ceiling cost, and/or other parameters may be based on the entity status of the first benefit entity. In some implementations, the first set of benefit parameters may be based on a premium paid by the first beneficiary to the first benefit entity in exchange for benefits. For example, the first beneficiary may pay a first premium to the first benefit entity in exchange for benefits characterized by the first set of benefit parameters. A second beneficiary may pay a second premium to the first benefit entity in exchange for benefits characterized by a second set of benefit parameters. The first premium may be different from the second premium and the first set of benefit parameters may be different than the second set of benefit parameters.

In some implementations, the beneficiary information may include a member identification number associated with the first beneficiary. The member identification number may be issued by the first benefit entity to identify the first beneficiary, such that the member identification number is unique to the first benefit entity and/or the first beneficiary. The member identification number may identify an individual beneficiary and/or a group of beneficiaries that receive benefits from the first benefit entity. The member idenfication number may be used to verify that the first beneficiary is associated with the first benefit entity and/or a first group of beneficiaries.

The therapy information may identify a first therapy intended for purchase by the first beneficiary and/or other therapies. In some implementations, therapy information may include a dosage, volume, brand, and/or other identifying information perataining to the therapy. The therapy may include drug therapies, physical therapies, and/or other types of medical treatments. In some implemenations, the first therapy may be obtained (i.e., purchased, acquired, serviced) from a vendor entity, a manufacturer entity, a healthcare entity, and/or other types of entities. In some implemenations, the price of the first therapy may vary based on the entity from which the first therapy is purchased. In some implementations, electronic storage 128 may store information pertaining to the first therapy. The information pertaining to the first therapy may include a list of entities (e.g., vendor entities, manufacturer entity, etc.) offering the first therapy for purchase, corresponding prices, and/or other information. For example, the price of the first therapy from a vendor entity may be higher than the price of the first therapy from a manufacturer entity.

In some implementations, the user interface may be capable of being accessed through one or more third-party applications and/or other applications (i.e., not included within system 100). The user interface may be embedded within the third-party application such that the user interface appears to be included within the third-party application. The user interface may be embedded within the third-party application using an application programing interface (API) and/or other integration methods. In some implementations, users may access system 100 through the third-party application using the API and/or through one or more networks 116. In some implementations, the third-party application may be a vendor application, a manufacturer application, a benefit entity application, a search engine application, and/or other types of applications. The vendor application may be an application associated with a vendor entity. The manufacturer application may be associated with a manufacturer entity. A benefit entity application may be associated with a benefit entity.

Information component 108 may be configured to, responsive to obtaining user input, obtain stored benefit information, from electronic storage 128, associated with the first benefit entity, stored cohort information associated with the first group of beneficiaries, and/or other information. Obtaining the stored benefit information associated with the first benefit entity may include obtaining an entity status (e.g., private or public) for the first benefit entity. In some implementations the first benefit entity may be a public benefit entity or a private benefit entity. Obtaining stored cohort information may include verifying the first set of benefit parameters (that is identified in the obtained user input) characterizes the same benefits (that are stored in electronic storage 128) received by the individual beneficiaries in the first group of beneficiaries. For example, information component 108 may confirm that the first beneficiary is provided the same benefits as the individual beneficiaries in the first group of beneficiaries.

In some implementations, information component 108 may be configured to obtain external information that is not stored in electronic storage 128 and/or other information from external resources 126. External information may be include information from databases associated (i.e., owned by, aggregated by, corresponding with) the benefit entities, vendor entities, manufacture entities, and/or other types of entities. In some implementations, access to an individual database may be provided by a license obtained from the individual entities associated with the individual database. External information may include information pertaining to benefit entities, beneficiaries associated with the benefit entities, therapy prices, and/or other information. For example, external information may include an up-to-date list of benefits and/or types of benefit plans provided by a given benefit entity, and/or other information. External information may include an up-to-date list of prices of therapies offered by a given vendor entity, and/or other information. In some implementations, information component 108 may obtain external information through one or more networks 116.

In some implementations, information component 108 may be configured to monitor information stored in electronic storage 128. The information stored in electronic storage 128 may include benefit information, the beneficiary information, the sets of benefit parameters, and/or other stored information. Monitoring may include comparing the stored information to the obtained external information to determine accuracy of the stored information. Responsive to a determination that the stored information is inaccurate, update the stored information to reflect the obtained external information. For example, information component 108 may compare a stored list (i.e., stored in electronic storage 128) of benefits and/or benefit plans provided by a first benefit entity with an obtained list (i.e., obtained from external resources 126) of benefits and/or benefit plans provided by a first benefit entity. Responsive to an indication that the obtained list includes information that is not included in the stored list, update the stored list to include the information. In some implementations, updating the stored information may include updating sets of benefit parameters for individual benefit entities, qualifying criteria for individual benefit entities, prices of therapies, and/or other changes to information stored in electronic storage 128. In some implementations, information stored in electronic storage 128 may be monitored and/or updated in an ongoing manner. The term “ongoing manner” as used herein may refer to contining to perform an action (e.g., monitoring, updating) periodically (e.g., every 30 seconds, every minute, every hour, etc.).

Qualification component 110 may be configured to determine whether the first beneficiary qualifies for additional benefits and/or other benefits. In some implementations, the additional benefits may be provided to the first beneficiary in addition to benefits provided by the first benefit entity. The additional benefits may be provided by one or more commercial entities and/or other entities. In some implementations, commercial entities may include entities that provide goods and services in exchange for consideration and/or for profit. Commercial entities may include private benefit entities, vendor entities, manufacturer entities, and/or other types of entities. The determination may be based on stored information associated with the first benefit entity, obtained beneficiary information associated with the first beneficiary, and/or other information. By way of non-limiting illustration, a determination that the first beneficiary qualifies for additional benefits may indicate the one or more entities providing payment on behalf of the first beneficiary for the first therapy.

In some implementations, the determination may be based on the entity status of the first benefit entity. By way of non-limiting example, responsive to the first benefit entity having a public status, a determination may be made that the first beneficiary does not qualify for additional benefits from one or more commercial entities. However, responsive to the first benefit entity having a public status, a determination may be made that the first beneficiary may qualify for additional benefits from one or more non-profit entities. By way of non-limiting example, responsive to the first benefit entity having a private status, a determination may be made that the first beneficiary qualifies for additional benefit from one or more commercial entities and/or other entities.

In some implementations, the determination whether the first beneficiary qualifies for additional benefits may be based on the first beneficiary meeting a qualifying criteria and/or other information. The qualifying criteria may include an income threshold, age threshold, and/or other criteria. In some implementations, the additional benefits may be provided to the first beneficiary based on the first therapy. For example, purchasing the first therapy may qualify the first beneficiary for benefits in the form of a discount (i.e., reduced price of the first therapy) from a given vendor entity, manufacturer entity, and/or other entities. In some implementations, the determination whether the first beneficiary qualifies for additional benefits may be based on the obtained beneficiary information associated with the first beneficiary, stored benefit information associated with the first benefit entity, stored information associated with the one or more entities providing the additional benefits, and/or other information.

In some implementations, additional benefits provided may be based on a hierarchy of qualifying criteria. For example, a first criteria defined by a first threshold and a second critera defined by a second threshold may correspond to a first level of benefits and a second level of benefits, respectively. The first threshold may be higher than the second threshold. By way of non-limiting example, the first threshold may correspond to a first annual income amount and the second threshold may correspond to a second annual income amount, such that the first annual income amount is less than the second annual income amount. Based on the beneficiaries having criteria that meet the first threshold, the beneficiaries may be provided benefits associated with the first level of benefits. Based on the beneficiaries having criteria that meet the second threshold, the beneficiaries may be provided benefits associated with the second level of benefits.

Cost component 112 may be configured to determine a beneficiary cost. The beneficiary cost may be based on the stored benefit information associated with the first benefit entity, the determination whether the first beneficiary qualifies for additional benefits, and/or other information. The beneficiary cost may indicate an amount to be paid by the first beneficiary for the first therapy subsequent to the first benefit entity and/or other entities (i.e., private benefit entities, vendor entities, manufacturer entities) providing payment for the first therapy. In some implementations, the beneficiary cost may be the whole price of the first therapy, no cost, and/or other portions of the price of the first therapy.

In some implementations, determining the beneficiary cost may include analyzing the stored cohort information associated with the first group of beneficiaries. The cohort information may include an average price paid by individuals of the first group of beneficiaries for the first therapy and/or other information. In some implementations, the cohort information may be used to verify the accuracy of the determined beneficiary cost. For example, the beneficiary cost may be compared to an average beneficiary cost stored in the cohort information. Responsive to the beneficiary cost being the same as or similar to the average beneficiary cost (i.e., within a difference threshold), the beneficiary cost may be determined to be valid. Responsive to the difference between the beneficiary cost and the average beneficiary cost exceeding the difference threshold, the beneficiary cost may be determined to be invalid and/or recalculated. In some implementations, the stored cohort information may be analyzed to determine which additional benefits beneficiaries of the first group of beneficiaries qualify for. In some implementations, the additional benefits that the first group of beneficiaries qualifies for may be the same as the additional benefits the first beneficiary qualifies for. The stored cohort information may be used as a reference for determining additional benefits for the first beneficiary. For example, individual beneficiaries of the first group of beneficiaries may qualify for a first additional benefit. Based on the first group of beneficiaries qualifying for the first additional benefit, qualification component 110 may check if the first beneficiary qualifies for the first additional benefit.

Determining the beneficiary cost may include calculating an entity-provided cost. The entity-provided cost may indicate an amount to be paid by at least one of the first benefit entity, the one or more public benefit entity, and/or other benefit entities. A portion of the entity-provided cost paid by the first benefit entity may be defined by the first set of benefit parameters. For example, the first set of benefit parameters may indicate a threshold amount to be paid by the first beneficiary prior to payment being provided by the first benefit entity. Responsive to the first therapy costing less than the threshold amount, the first benefit entity will not provide payment. In some implementations, the entity-provided cost may be provided by only the first benefit entity, responsive to the determination that the first beneficiary does not qualify for additional benefits. In some implementations, the entity-provided cost may be provided by the first benefit entity and/or entities providing additional benefits, responsive to the determination that the first beneficiary does qualify for additional benefits. The portion of the entity-provided costs provided by the entities providing additional benefits may be determined by the hierarchy of benefits associated with individual ones of the entities providing additional benefits. In some implementations, calculating the entity-provided cost may be based on the deductible cost, the ceiling cost, and/or other parameters.

Presentation component 114 may be configured to effectuate presentation of the beneficiary cost via the user interface. The beneficiary cost may be based on the entity-provided cost deducted from a total cost for the first therapy. In some implementations, presentation of the beneficiary cost may include presentation of the total price of the first therapy, the portion of the entity-provided costs provided by the first benefit entity, the portion of the entity-provided cost provided by the entities providing additional benefits, and/or other information. In some implementations, the user interface may include one or more user interface elements and/or other elements. The user interface elements may include clickable links to external application where users may purchase the first therapy.

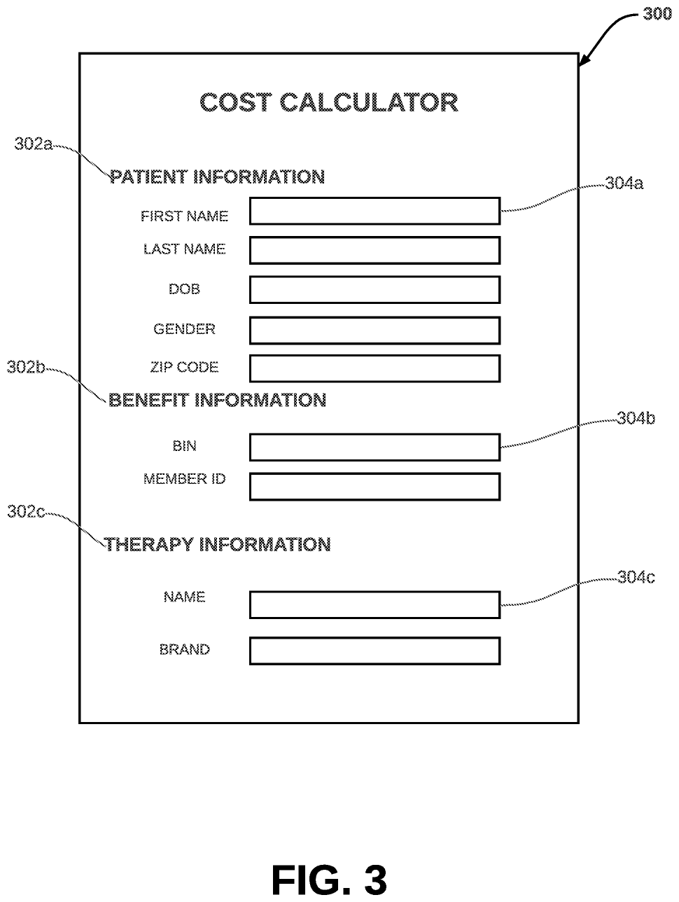

FIG. 3 illustrates a user interface 300, in accordance with one or more implementations. User interface 300 may be accessed through one or more client computing platform(s) 104. In some implementations user interface 300 may be embedded and/or integrated into a third-party application via one or more application programming interfaces through one or more networks 116. User interface 300 may include one or more user input fields 304a-c and/or other user interface elements. The user input fields 304a-c may be configured to receive user input specifying input information. The input information may include one or more input categories 302a-c, and/or other information. The input categories shown in FIG. 3 are for illustrative purposes only and not intended to be limiting. In some implementations, the input information specified by user input via user interface 300 may be used to determine beneficiary costs for one or more therapies that are specified by the user.

In some implementations, server(s) 102, client computing platform(s) 104, and/or external resources 126 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 126 may be operatively linked via some other communication media.

A given client computing platform 104 may include one or more processors configured to execute computer program components. The computer program components may be configured to enable an expert or user associated with the given client computing platform 104 to interface with system 100 and/or external resources 126, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 126 may include sources of information outside of system 100, external entities participating with system 100, and/or other resources. In some implementations, some or all of the functionality attributed herein to external resources 126 may be provided by resources included in system 100.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, and/or 114, and/or other components. Processor(s) 130 may be configured to execute components 108, 110, 112, and/or 114, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, and/or 114 are illustrated in FIG. 1 as being implemented within a single processing unit, in implementations in which processor(s) 130 includes multiple processing units, one or more of components 108, 110, 112, and/or 114 may be implemented remotely from the other components. The description of the functionality provided by the different components 108, 110, 112, and/or 114 described below is for illustrative purposes, and is not intended to be limiting, as any of components 108, 110, 112, and/or 114 may provide more or less functionality than is described. For example, one or more of components 108, 110, 112, and/or 114 may be eliminated, and some or all of its functionality may be provided by other ones of components 108, 110, 112, and/or 114. As another example, processor(s) 130 may be configured to execute one or more additional components that may perform some or all of the functionality attributed below to one of components 108, 110, 112, and/or 114.

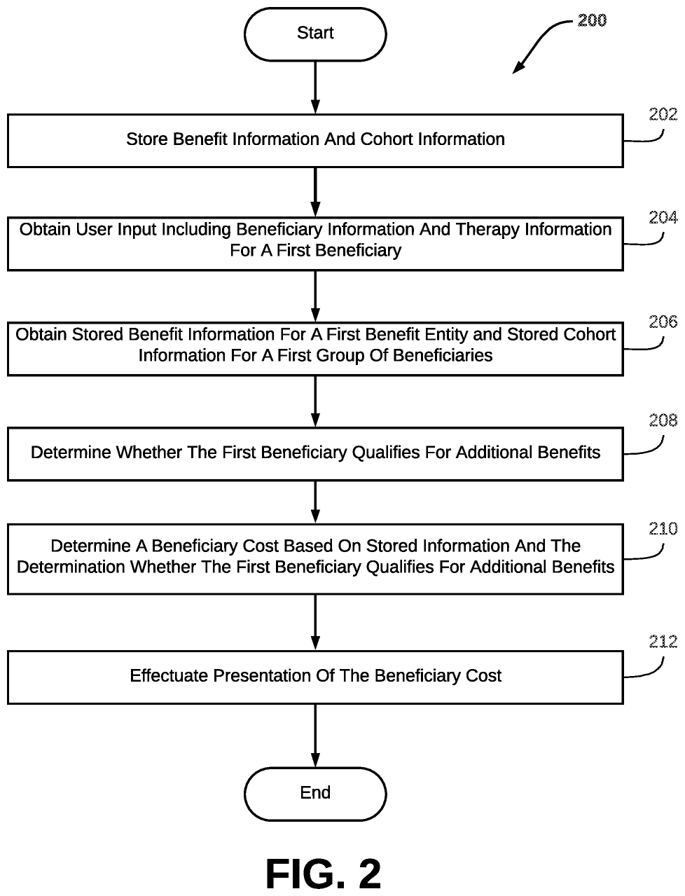

FIG. 2 illustrates a method 200 for determining beneficiary costs based on benefit information, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include storing benefit entity information, cohort information, and/or other information. The benefit entity information may be associated with benefit entities that provide benefits to beneficiaries. The benefits may include payment for health and medical services on behalf of the beneficiary and/or other forms of benefits. The benefit entity information may include sets of benefit parameters (e.g., insurance plans, insurance policy, etc.) that characterize the benefits provided by the individual benefit entities, and/or other information. The benefit entity information associated with the benefit entities may indicate whether the individual benefit entities have a public status, a private status, and/or other statuses. The benefits may include payment for health and medical services on behalf of the beneficiary and/or other forms of benefits. The cohort information may be associated with groups of beneficiaries. Individual beneficiaries belonging to an individual group of beneficiaries may receive the same benefits that are defined by an individual set of benefit parameters. Operation 202 may be performed by one or more electronic storage media and/or electronic storage components that is the same as or similar to electronic storage 128, in accordance with one or more implementations.

An operation 204 may include obtaining user input submitted by a user via a user interface. The user input may include beneficiary information, therapy information, and/or other information. The beneficiary information may identify at least one of a first beneficiary, a first benefit entity, a first set of benefit parameters, and/or other elements. The first set of benefit parameters may characterize benefits provided by the first benefit entity to the first beneficiary. The therapy information may identify a first therapy intended for purchase by the first beneficiary and/or other therapies. Operation 204 may be performed by one or more hardware processors configured by machine-readable instructions including a component that is the same as or similar to information component 108, in accordance with one or more implementations.

An operation 206 may include, responsive to obtaining user input, obtaining stored benefit information associated with the first benefit entity, stored cohort information associated with a first group of beneficiaries, and/or other information. The first group of beneficiaries may receive benefits from the first benefit entity that are the same as the benefit received by the first beneficiary. Obtaining the stored benefit information associated with the first benefit entity may include obtaining an entity status for the first benefit entity. Obtaining the stored cohort information may include verifying the first set of benefit parameters characterizes the benefits received by the individual beneficiaries of the first group of beneficiaries. Operation 206 may be performed by one or more hardware processors configured by machine-readable instructions including a component that is the same as or similar to information component 108, in accordance with one or more implementations.

An operation 208 may include determining whether the first beneficiary qualifies for additional benefits and/or other benefits. The determination may be based on one or more of the entity status of the first benefit entity, stored benefit information associated with the first benefit entity, stored cohort information associated with the first group of beneficiaries, beneficiary information obtained from the user, and/or other information. A determination that the first beneficiary qualifies for additional benefits may indicate one or more entities providing payment on behalf of the first beneficiary for the first therapy in addition to the benefits provided by the first benefit entity. Operation 208 may be performed by one or more hardware processors configured by machine-readable instructions including a component that is the same as or similar to qualification component 110, in accordance with one or more implementations.

An operation 210 may include determining a beneficiary cost. The beneficiary cost may be based on the stored benefit information associated with the first benefit entity, the stored cohort information associated with the first group of beneficiaries, the determination whether the first beneficiary qualifies for additional benefits, and/or other information. The beneficiary cost may indicate an amount to be paid by the first beneficiary for the first therapy. Determining the beneficiary cost may include calculating an entity-provided cost and/or other costs. The entity-provide cost may indicate an amount to be paid by one or more of the first benefit entity, the one or more entities providing additional benefits, and/or other entities. A portion of the entity-provided cost may be paid by the first benefit entity and/or may be defined by the first set of benefit parameters. Operation 210 may be performed by one or more hardware processors configured by machine-readable instructions including a component that is the same as or similar to cost component 112, in accordance with one or more implementations.

An operation 212 may include effectuating presentation of the beneficiary costs via the user interface. The beneficiary cost may be based on the entity-provided cost deducted from a total cost for the first therapy and/or other information. Operation 212 may be performed by one or more hardware processors configured by machine-readable instructions including a component that is the same as or similar to presentation component 114, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system to determine beneficiary costs based on benefit information, the system comprising:
electronic storage media that stores benefit entity information and cohort information, wherein benefit entity information is associated with a multitude of benefit entities that provide a multitude of benefits to beneficiaries, the benefits including payment for health and medical services on behalf of the beneficiaries, wherein the benefit entity information includes sets of benefit parameters that characterize the benefits provided by the individual benefit entities, wherein the benefit entity information associated with the individual benefit entities indicates whether the individual benefit entities have a public status or a private status, and wherein cohort information is associated with groups of beneficiaries, wherein individual beneficiaries belonging to an individual group of beneficiaries receive the same benefits defined by an individual set of benefit parameters; and
one or more physical computing processors configured by machine-readable instructions to:
obtain user input submitted by a user via a user interface, the user input including beneficiary information and therapy information, wherein the user interface is embedded within a third-party application through an application programing interface, wherein the third party application is associated with a vendor application, wherein the beneficiary information identifies at least one of a first beneficiary, a first benefit entity, and a first set of benefit parameters characterizing benefits provided by the first benefit entity to the first beneficiary, and wherein the therapy information identifies a first therapy intended for purchase by the first beneficiary;
responsive to obtaining user input, obtain stored benefit information associated with the first benefit entity and stored cohort information associated with a first group of beneficiaries, wherein the first group of beneficiaries receives benefits from the first benefit entity that are the same as the benefits received by the first beneficiary, wherein obtaining the stored benefit information associated with the first benefit entity includes obtaining an entity status for the first benefit entity, and wherein obtaining stored cohort information includes verifying that the first set of benefit parameters characterizes the benefits received by individual beneficiaries of the first group of beneficiaries;
determine whether the first beneficiary qualifies for additional benefits, wherein the determination is based on at least one of the entity status of the first benefit entity, stored benefit information associated with the first benefit entity, stored cohort information associated with the first group of beneficiaries, and beneficiary information obtained from the user, and wherein a determination that the first beneficiary qualifies for additional benefits indicates one or more entities providing payment on behalf of the first beneficiary for the first therapy in addition to the benefits provided by the first benefit entity;
determine a beneficiary cost based on the stored benefit information associated with the first benefit entity, the stored cohort information associated with the first group of beneficiaries, and the determination whether the first beneficiary qualifies for additional benefits, wherein the beneficiary cost indicates an amount to be paid by the first beneficiary for the first therapy, wherein determining the beneficiary cost includes calculating an entity-provided cost indicating an amount to be paid by at least one of the first benefit entity and the one or more entities providing additional benefits, and wherein a portion of the entity-provided cost paid by the first benefit entity is defined by the first set of benefit parameters;
effectuate presentation of the beneficiary cost via the user interface, wherein the beneficiary cost is based on the entity-provided cost deducted from a total cost for the first therapy.

2. The system of claim 1, wherein the first set of benefit parameters includes individual benefit parameters characterizing a deductible cost and a ceiling cost, wherein the deductible cost indicates a required amount to be paid by the first beneficiary for the first therapy prior to the first benefit entity providing payment, and wherein the ceiling cost indicates a maximum amount paid by the first benefit entity.

3. The system of claim 2, wherein the deductible cost and ceiling cost are based on the entity status of the first benefit entity.

4. The system of claim 2, wherein calculating the entity-provided cost is based on the deductible cost and the ceiling cost.

5. (canceled)

6. The system of claim 1, wherein the third-party application is associated with a manufacturer application, a benefit entity application, or a search engine application.

7. The system of claim 1, wherein the one or more hardware processors are further configured by machine readable instructions to:
obtain external information from external resources, wherein the external resources include databases associated with the benefit entities, and wherein access to an individual database is provided by a license obtained from the individual benefit entity associated with the individual database.

8. The system of claim 7, wherein the one or more hardware components are further configured by machine-readable instructions to:
monitor the stored benefit information and stored cohort information, wherein monitoring includes comparing the stored information to obtained external information to determine accuracy of the stored information;
responsive to a determination that the stored information is inaccurate, update the stored information to reflect the obtained external information.

9. The system of claim 1, wherein the obtained beneficiary information includes a member identification number associated with the first beneficiary, wherein the member identification number is issued by the first benefit entity to identify the first beneficiary.

10. The system of claim 1, wherein the additional benefits are provided by one or more commercial entities, wherein an individual commercial entity is a private benefit entity, a vendor entity, or a manufacturer entity.

11. A method for determining beneficiary costs based on benefit information, the method comprising:
storing benefit entity information and cohort information, wherein benefit entity information is associated with a multitude of benefit entities that provide a multitude of benefits to beneficiaries, the benefits including payment for health and medical services on behalf of the beneficiaries, wherein the benefit entity information includes sets of benefit parameters that characterize the benefits provided by the individual benefit entities, wherein the benefit entity information associated with the individual benefit entities indicates whether the individual benefit entities have a public status or a private status, and wherein cohort information is associated with groups of beneficiaries, wherein individual beneficiaries belonging to an individual group of beneficiaries receive the same benefits defined by an individual set of benefit parameters;
obtaining user input submitted by a user via a user interface, the user input including beneficiary information and therapy information, wherein the user interface is embedded within a third-party application through an application programing interface, wherein the third party application is associated with a vendor application, wherein the beneficiary information identifies at least one of a first beneficiary, a first benefit entity, and a first set of benefit parameters characterizing benefits provided by the first benefit entity to the first beneficiary, and wherein the therapy information identifies a first therapy intended for purchase by the first beneficiary;
responsive to obtaining user input, obtaining stored benefit information associated with the first benefit entity and stored cohort information associated with a first group of beneficiaries, wherein the first group of beneficiaries receives benefits from the first benefit entity that are the same as the benefits received by the first beneficiary, wherein obtaining the stored benefit information associated with the first benefit entity includes obtaining an entity status for the first benefit entity, and wherein obtaining stored cohort information includes verifying the first set of benefit parameters characterizes the benefits received by individual beneficiaries of the first group of beneficiaries;
determining whether the first beneficiary qualifies for additional benefits, wherein the determination is based on at least one of the entity status of the first benefit entity, stored benefit information associated with the first benefit entity, stored cohort information associated with the first group of beneficiaries, and beneficiary information obtained from the user, and wherein a determination that the first beneficiary qualifies for additional benefits indicates one or more entities providing payment on behalf of the first beneficiary for the first therapy in addition to the benefits provided by the first benefit entity;
determining a beneficiary cost based on the stored benefit information associated with the first benefit entity, the stored cohort information associated with the first group of beneficiaries, and the determination whether the first beneficiary qualifies for additional benefits, wherein the beneficiary cost indicates an amount to be paid by the first beneficiary for the first therapy, wherein determining the beneficiary cost includes calculating an entity-provided cost indicating an amount to be paid by at least one of the first benefit entity and the one or more entities providing additional benefits, and wherein a portion of the entity-provided cost paid by the first benefit entity is defined by the first set of benefit parameters;
effectuating presentation of the beneficiary cost via the user interface, wherein the beneficiary cost is based on the entity-provided cost deducted from a total cost for the first therapy.

12. The method of claim 11, wherein the first set of benefit parameters includes individual benefit parameters characterizing a deductible cost and a ceiling cost, wherein the deductible cost indicates a required amount to be paid by the first beneficiary for the first therapy prior to the first benefit entity providing payment, and wherein the ceiling cost indicates a maximum amount paid by the first benefit entity.

13. The method of claim 12, wherein the deductible cost and ceiling cost are based on the entity status of the first benefit entity.

14. The method of claim 12, wherein calculating the entity-provided cost is based on the deductible cost and the ceiling cost.

15. (canceled)

16. The method of claim 1, wherein the third-party application is associated with a manufacturer application, a benefit entity application, or a search engine application.

17. The method of claim 11, wherein the method further comprises:
obtaining external information from external resources, wherein the external resources include databases associated with the benefit entities, and wherein access to an individual database is provided by a license obtained from the individual benefit entity associated with the individual database.

18. The method of claim 17, wherein the method further comprises:
monitoring the stored benefit information and the stored cohort information, wherein monitoring includes comparing the stored information to obtained external information to determine accuracy of the stored information;
responsive to a determination that the stored information is inaccurate, updating the stored information to reflect the obtained external information.

19. The method of claim 11, wherein the obtained beneficiary information includes a member identification number associated with the first beneficiary, wherein the member identification number is issued by the first benefit entity to identify the first beneficiary.

20. The method of claim 1, wherein the additional benefits are provided by one or more commercial entities, wherein an individual commercial entity is a private benefit entity, a vendor entity, or a manufacturer entity.
